(19) United States
(12) Patent Application Publication
(10) Pub. No.: US 2026/0177445 A1
(43) Pub. Date: Jun. 25, 2026

(54) CENTRAL UNIT AND SYSTEM OF CENTRAL UNITS FOR DETECTING AND LOCATING LIQUID LEAKS

(71) Applicant: TTK, Paris (FR)

(72) Inventors: Olivier GAUTIER, Paris (FR); Olivier GILLOT, Paris (FR)

(21) Appl. No.: 19/126,343

(22) PCT Filed: Nov. 7, 2023
(86) PCT No.: PCT/EP2023/080955

§ 371 Date: May 1, 2025

(30) Foreign Application Priority Data
Nov. 15, 2022 (FR) FR2211882

(51) Int. Cl. G01M 3/16

(52) U.S. Cl. CPC G01M 3/165

(57) ABSTRACT

A main central unit and a system including the main central unit and at least one secondary central unit, the secondary central unit having at least one leak detection circuit configured to receive at least one detection line, the secondary central unit also having an Ethernet cable power supply interface configured to receive a single network cable for supplying power to the secondary central unit and providing network communication, the main central unit and the at least one secondary central unit communicating with one other via a communication network supplied via the single network cable.

### TECHNICAL FIELD

The present invention relates to a central unit for detecting and locating liquid leaks using detection cables. It also relates to a system of central units for detecting and locating liquid leaks using detection cables.

### PRIOR ART

To detect liquid leaks over long distances, such as oil or water pipelines, or over large surfaces, such as industrial premises or computer rooms, it is known to install detection cables connected together in series to form a detection line.

In such a detection line, each cable comprises an elongate portion which includes, along all or part of its length, a means sensitive to the liquid(s) to be detected. The cables also comprise a communication bus in their elongate part, which are connected together to form a query bus running the entire length of the detection line. The end of the detection line is connected to a central unit.

Today, there are a number of different central systems for managing cable detection lines. However, the number of cables handled by the central unit can quickly be limited when used on a large scale. Powering these central units can sometimes be a real problem.

The aim of the present invention is to resolve at least one of these shortcomings.

### DISCLOSURE OF THE INVENTION

This aim is achieved with a central unit for detecting and locating liquid leaks using at least one detection cable, the central unit comprising at least one leak detection circuit, each leak detection circuit being configured to receive the at least one detection cable, characterized in that the central unit comprises an Ethernet cable power supply interface configured to receive a single network cable for powering the central unit and providing network communication.

The advantage of the central unit according to the invention is to simplify its wiring. This makes it possible to have a central unit that communicates with a main central unit via a communication network supplied by a network cable for power and network. The power supplied by the dedicated network cable depends on the class of source equipment to which it is connected.

Additionally, this central unit extends the number of detection cables to be monitored when coupled to a main central unit, owing to the detection circuits present in the central unit. The central unit can then be used to add at least one additional detection circuit.

The central unit according to the invention can supervise a large number of cables, for example, forty water/acid detection cables per detection circuit or equivalent. In another embodiment, the central unit can supervise fifty-nine hydrocarbon detection cables or equivalent per detection circuit.

The central unit also drastically reduces power consumption, as it is powered by the Ethernet network cable rather than a mains supply. This modification also makes it possible to connect more central units together on a single communication network, such as Ethernet.

A first detection cable is connected to the detection circuit of said central unit. The detection cable connected at a first end can be connected at a second end to a second detection cable. There is no limit to the number of cables connected in series. This series of detection cables forms a detection line.

In addition, the detection line, regardless of the number of detection cables that make it up, can be connected to a detection circuit by one of its ends, or to two detection circuits of the same central unit, each end being connected to one of the detection circuits of said central unit.

Advantageously, said central unit can comprise at least two leak detection circuits. Depending on the embodiment, a single circuit may be used on both, for example.

The at least one leak detection circuit may be a water/acid detection circuit or a hydrocarbon detection circuit.

Depending on the embodiment, the central unit may comprise, for example, only water/acid detection circuits or only hydrocarbon detection circuits. The central unit can also comprise a combination of the two types of detection circuits. This allows different types of leak to be detected by a single central unit.

In yet another aspect of the invention, a system of central units for detecting and locating liquid leaks using detection cables is proposed, comprising a main central unit and at least one central unit according to the invention, the main central unit and the at least one central unit communicating with one another via a communication network supplied by the single network cable.

The main central unit can be used to shut down faulty detection circuits and/or detect leaks. The main central unit can also advantageously communicate with other systems, such as PLCs and supervisory computers, via a Modbus or Ethernet network.

The communication network can be an Ethernet network. The main central unit communicates with the central units according to the invention via the Ethernet communication network provided by the single network cable used to power said central unit and ensure network communication.

Each central unit, together with the main central unit, comprises a single network cable connected to the communication network. The communication network, e.g. Ethernet, then becomes common to all central units connected thereto. Conversely, only the main central unit is powered by a mains supply.

The main central unit can comprise at least one man-machine interface and at least one communication device. This allows the user to interact with the system of central units. Advantageously, the communication device corresponds to an LCD touch screen. This allows the user to visualize any leaks in the system, for example.

### DESCRIPTION OF THE FIGURES AND EMBODIMENTS

Other benefits and features of the invention shall become evident upon examining the detailed description of entirely non-limiting implementations and embodiments, and from the following enclosed drawings:

FIG. 1 shows a central unit according to the invention.

These embodiments are in no way limiting, and, in particular, it is possible to consider variants of the invention that comprise only a selection of the features disclosed hereinafter in isolation from the other features disclosed (even if that selection is isolated within a phrase comprising other features), if this selection of features is sufficient to confer a technical benefit or to differentiate the invention with respect to the prior art. This selection comprises at least one preferably functional feature which lacks structural details, and/or only has a portion of the structural details if that portion alone is sufficient to confer a technical benefit or to differentiate the invention with respect to the prior art.

The central unit according to the invention is part of a system of central units for detecting and locating liquid leaks using detection cables connected in series. This system comprises a main central unit and at least one central unit 1 according to the invention. The main central unit can communicate with a plurality of central units 1.

For the sake of brevity, the central unit according to the invention will be referred to as a “secondary central unit” in this description. The main central unit and the at least one secondary central unit 1 communicate with one another via a communication network. The communication network is an Ethernet network. The Ethernet network is supplied by a single cable to power said central unit 1 and ensure network communication. The main central unit and the at least one secondary central unit 1 each have their own network cable and dedicated power supplies. The main central unit has a mains power supply, while the at least one secondary central unit 1 is powered via the single cable described above.

Each detection cable comprises a detector. This detector comprises a management module, which is connected to a detection member elongate along the entire length of the detection cable. When detecting a conductive liquid, such as water/basic acid, the resistivity of the detection member decreases on contact with said liquid. When detecting a non-conductive liquid, such as a hydrocarbon or solvent, for example, the resistivity of the detection member increases on contact with said liquid. In addition to the detector element, the linear sensor comprises a communication element which includes two communication conductors and two power conductors running along the entire length of the detection cable.

A detection line is formed by a plurality of detection cables 4 connected in series. The detection line is used to detect leaks. When a leak is detected, the information is sent back to the main central unit or secondary central unit 1 via said detection line.

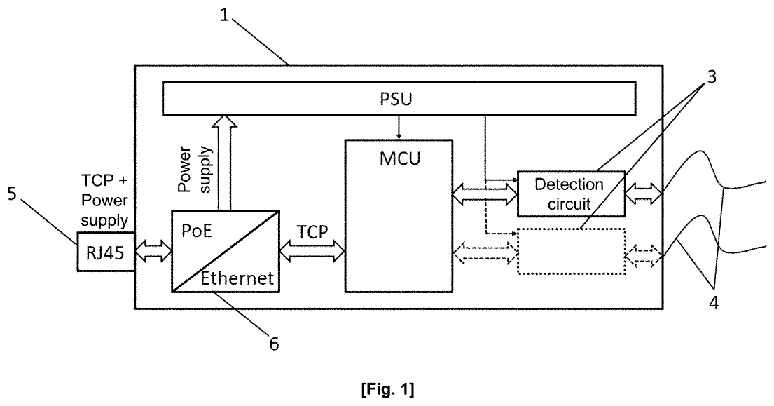

With reference to FIG. 1, a secondary central unit according to the invention will now be described.

The secondary central unit 1 according to the invention comprises an input 5 configured to receive and connect a network cable enabling the secondary central unit 1 to be supplied with network and power. Each secondary central unit 1 is connected to a single network cable. Each single network cable is connected to the Ethernet communication network, enabling all the central units connected thereto to communicate with one another. For the purposes of the present invention, the secondary central unit 1 does not comprise a dedicated mains supply input.

In the embodiment shown, the secondary central unit 1 comprises two detection circuits 3, each designed to receive, via dedicated inputs, a detection line made up of a plurality of detection cables 4 connected in series. The other end of the detection lines can be connected either to the same central unit on a second detection circuit 3, or to the main central unit, or to another secondary central unit 1 on one of its detection circuits 3, or to an end-of-line plug. A single detection circuit 3 is used here. The number of detection circuits in a secondary central unit 1 is not limited, and the number of detection circuits used depends on the requirements. The secondary central unit 1 also comprises a power supply unit (PSU) and a microcontroller unit (MCU).

The secondary central unit 1 comprises an Ethernet network cable power supply interface 6 configured to receive the single network cable on an input 5. The network cable can be an RJ45-type cable.

The various components of the secondary central unit 1, such as the microcontroller, power supply unit and detection circuits, are supplied with power and network via the Ethernet/PoE (Power over Ethernet) interface 6, where the single cable is connected.

Typically at least one of the means of the device according to the invention previously described, preferably each of the means of the device according to the invention previously described, are technical means.

Typically, each means of the device according to the invention previously disclosed comprises at least one computer, a central processing or computing unit, an analog electronic circuit (preferably dedicated), a digital electronic circuit (preferably dedicated), and/or a microprocessor (preferably dedicated), and/or software means.

Of course, the invention is not limited to the examples just described, and many adjustments can be made to these examples without going beyond the scope of the invention.

Of course, the various features, forms, variants and embodiments of the invention may be combined with each other in various combinations as long as they are not incompatible or exclusive of each other. In particular, all the variants and embodiments described above can be combined with each other.

1-6. (canceled)

7. A system of central units for detecting and locating liquid leaks using at least one detection line formed by a plurality of detection cables in series, the system comprising a main central unit and at least one secondary central unit, the secondary central unit comprising at least one leak detection circuit configured to receive at least one detection line, the secondary central unit also comprising an Ethernet cable power supply interface configured to receive a single network cable for supplying power to said secondary central unit and providing network communication, the main central unit and the at least one secondary central unit communicating with one other via a communication network supplied via the single network cable.

8. The system of central units according to claim 7, wherein said secondary central unit comprises at least two leak detection circuits.

9. The system of central units according to claim 7, wherein at least one leak detection circuit corresponds to a water/acid detection circuit or a hydrocarbon detection circuit.

10. The system of central units according to claim 7, wherein the communication network corresponds to an Ethernet network.

11. The system of central units according to claim 7, wherein the main central unit comprises at least one man-machine interface and at least one communication device.
